(19) United States
(12) Patent Application Publication
(10) Pub. No.: US 2015/0169743 A1
(43) Pub. Date: Jun. 18, 2015

(54) PROFILE MANAGEMENT SYSTEM, INFORMATION DEVICE, PROFILE UPDATING METHOD, AND RECORDING MEDIUM STORING COMPUTER PROGRAMS

(71) Applicant: Konica Minolta, Inc., Chiyoda-ku (JP)

(72) Inventors: Kagumi MORIWAKI, Kawanishi-shi (JP); Yoichi Kawabuchi, Itami-shi (JP); Toshihiro Motoi, Toshima-ku (JP); Noriko Hoshino, Kokubunji-shi (JP)

(73) Assignee: KONICA MINOLTA, INC., Tokyo (JP)

(21) Appl. No.: 14/569,951

(22) Filed: Dec. 15, 2014

(30) Foreign Application Priority Data
Dec. 16, 2013 (JP) 2013-258847

(51) Int. Cl. G06F 17/30; G06F 7/24

(52) U.S. Cl. CPC G06F 17/30702; G06F 7/24

(57) ABSTRACT

A profile management system managing a profile created for an individual person, includes: a document separation unit that separates documents specified as targets of processing by a user of a device handling document data, into event documents related to events scheduled to be held or having been already held and other documents; an importance determination unit that determines whether an event related to the event document separated by the document separation unit is important for the user, based on information recorded in a personal profile corresponding to the user and information recorded in an event profile corresponding to the event; and a personal profile edit unit that extracts words from an event document related to an event determined as important by the importance determination unit, out of the event documents separated by the document separation unit, and records the words as keywords in the personal profile corresponding to the user.

The entire disclosure of Japanese Patent Application No. 2013-258847 filed on Dec. 16, 2013 including description, claims, drawings, and abstract are incorporated herein by reference in its entirety.

### BACKGROUND OF THE INVENTION

1. Field of the Invention

The present invention relates to a technique for providing personal profiles indicating trends in personal collection of information.

2. Description of the Related Art

There is a technique for automatically extracting keywords from documents viewed or saved by users with information devices and recording the same in personal profiles. The personal profiles updated by the technique are utilized as information indicative of users' interests and concerns for automatic selection of documents seemed as useful for the users, profile search for looking for persons with interests in the same things, filtering of e-mail, or the like, for example.

Meanwhile, conference documents such as meeting minutes and handouts are frequently compiled into databases. Extraction of keywords from the conference documents for registration into the databases makes it easy for users to search desired conference documents. Conventionally, there has been suggested a conference keyword extraction device that determines the numbers of appearances and the inverse frequencies of phrases in conference documents to define the degrees of importance of the phrases, and extracts phrases with higher degrees of importance as keywords (refer to JP 2012-038064 A).

At offices or other workplaces, words may be extracted from documents with which working persons are involved, and recorded in personal profiles as keywords for identifying personal interests. The documents with which working persons are involved include conference documents as documents related to various conferences. Conferences are typical events in workplaces. The conference documents include opening notices, minutes, agendas, handouts, and the like.

In general, conferences attended by a working person deeply relate to his/her business operations. The documents for the conferences thus frequently contain words highly interesting to him/her. In addition, documents for a conference may be made open to working persons other than those slated to participate in the conference, and the documents may contain words that interest the working persons.

However, all of the conference documents a working person has in hand may not necessarily contain words interesting to him/her. That is, the working person may obtain conference documents that are less important for him/her. For example, he/she may attend a committee meeting for in-house activities such as promotion of safety and health as a representative of his/her department, or he/she may join a meeting for an in-house recreation as one of several facilitators. Conference documents for such meetings as described above hardly contain information useful to the working person's daily business operations.

### SUMMARY OF THE INVENTION

In light of such circumstances, an object of the present invention is to increase the accuracy of personal profiles as information for identifying personal interests.

To achieve the abovementioned object, according to an aspect, a profile management system managing a profile created for an individual person reflecting one aspect of the present invention comprises: a document separation unit that separates documents specified as targets of processing by a user of a device handling document data, into event documents related to events scheduled to be held or having been already held and other documents; an importance determination unit that determines whether an event related to the event document separated by the document separation unit is important for the user, based on information recorded in a personal profile corresponding to the user and information recorded in an event profile corresponding to the event; and a personal profile edit unit that extracts words from an event document related to an event determined as important by the importance determination unit, out of the event documents separated by the document separation unit, and records the words as keywords in the personal profile corresponding to the user.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram showing an example of a computing environment of an embodiment of the present invention;

FIG. 2 is a diagram showing a hardware configuration of a user terminal;

FIG. 3 is a diagram showing a functional configuration of a profile management system;

FIG. 4 is a diagram showing a mode of acquisition of a conference profile by the user terminal;

FIGS. 5A and 5B are diagrams showing an example of a data configuration of a personal profile;

FIGS. 6A and 6B are diagrams showing an example of a data configuration of the conference profile;

FIG. 7 is a flowchart showing an overview of operations of the profile management system;

FIG. 8 is a flowchart of an event importance determination subroutine;

FIG. 9 is a diagram showing a modification example of operations of a personal profile edit unit;

FIG. 10 is a diagram showing an example of personal profiles;

FIG. 11 is a flowchart of a conference profile creation process;

FIG. 12 is a diagram showing a modification example of a utilization mode of the personal profile;

FIG. 13 is a diagram showing another example of a configuration of the profile management system; and

FIG. 14 is a diagram showing an example of a setting table for determination on degree of importance according to combinations of processes on a conference document and attendance at/absence from a conference.

### DESCRIPTION OF THE PREFERRED EMBODIMENTS

Hereinafter, an embodiment of the present invention will be described with reference to the drawings. However, the scope of the invention is not limited to the illustrated examples.

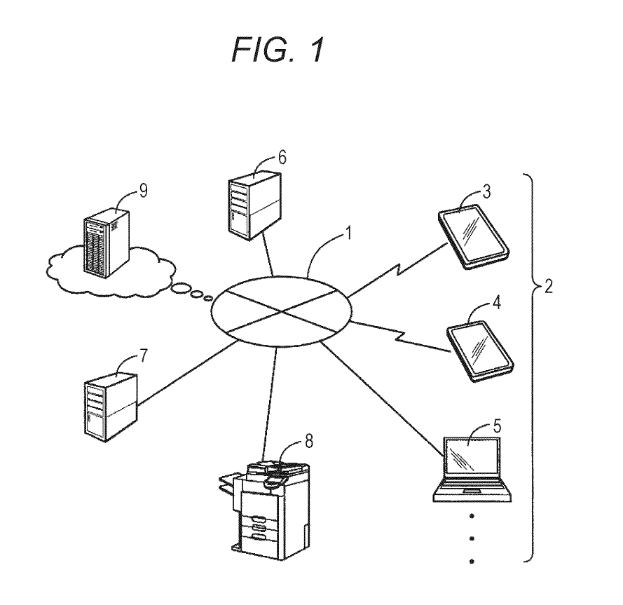

In a computing environment shown in FIG. 1, personal profiles can be managed using a profile management system.

One or more user terminals 2 are connected to a network 1. Each of the user terminals 2 is basically an information device used by one user. In FIG. 1, tablets 3, 4, and a laptop personal computer 5 are represented as the user terminals 2. Each of the user terminals 2 is configured to be communicable with other information devices such as a file server 6, a management server 7, an MFP (Multi-functional Peripheral) 8, and a cloud server 9 on the network 1. The user terminals 2 can also communicate with each other. Communication modes may be wired, wireless, or a combination thereof.

In the embodiment, personal profiles are created for the users of the user terminals 2. In one mode for management of personal profiles, the plurality of user terminals 2 individually create personal profiles and manage the same therein, and in the other mode, a device other than the user terminals 2 collectively manages personal profiles corresponding to the plurality of user terminals 2. In the following descriptions, examples of system configurations in these modes will be taken.

The term “document” refers to electronic data that is processed in a predetermined batch and contains bit strings indicative of linguistic words. The form of data is not limited to text, but may be sound, image, or any other form as far as word extraction by data processing is allowed in the data form.

[System Configuration 1]

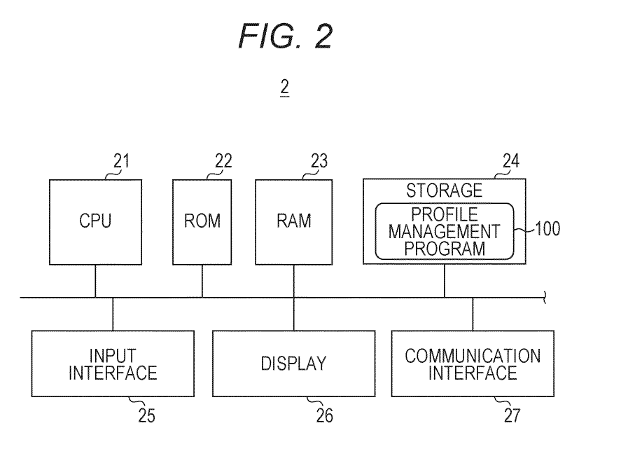

The user terminal 2 manages a personal profile corresponding to its user. When the plurality of user terminals 2 is connected to the network 1, all of the user terminals 2 do not necessarily have the function of managing personal profiles. At least one of the user terminals 2 needs to have the function. FIG. 2 shows a hardware configuration of the user terminal 2.

As shown in FIG. 2, the user terminal 2 includes a CPU (Central Processing Unit) 21, a ROM (Read Only Memory) 22, a RAM (Random Access Memory) 23, a storage 24, an input interface 25, a display 26, a communication interface 27, and other elements not shown.

The CPU 21 loads a program stored in the ROM 22 or the storage 24 into the RAM 23 to execute the same. The storage 24 is a solid state drive (SSD) or another non-volatile memory device that can store a profile management program 100. The storage 24 may be a hard disc drive. The profile management program 100 is stored in the storage 24 by downloading from a predetermined server or installing from a removable medium. The CPU 21 executes the profile management program 100 to implement a profile management system described later.

The input interface 25 includes one or more input devices that output a signal according to an operational input action by the user. For example, when the user terminal 2 is a tablet, the input interface 25 includes a touch panel in close contact with the display. When the user terminal 2 is a laptop or desktop personal computer, the input interface 25 includes a keyboard and a mouse (or another pointing device). When the user terminal 2 is configured to receive voice operations, the input interface 25 includes a microphone.

The display 26 is a device that provides a screen on a liquid crystal panel, an organic electroluminescence panel, or another panel. When the user terminal 2 is a desktop personal computer, the display 26 is generally separated from a main body including the CPU 21 and connected to the main body via an external connection cable.

The communication interface 27 is equipped with a device for wired communications and a device for wireless communications. Wireless communications include communications under WLAN (Wireless Local Area Network) standards and communications under Bluetooth (registered trademark) standards.

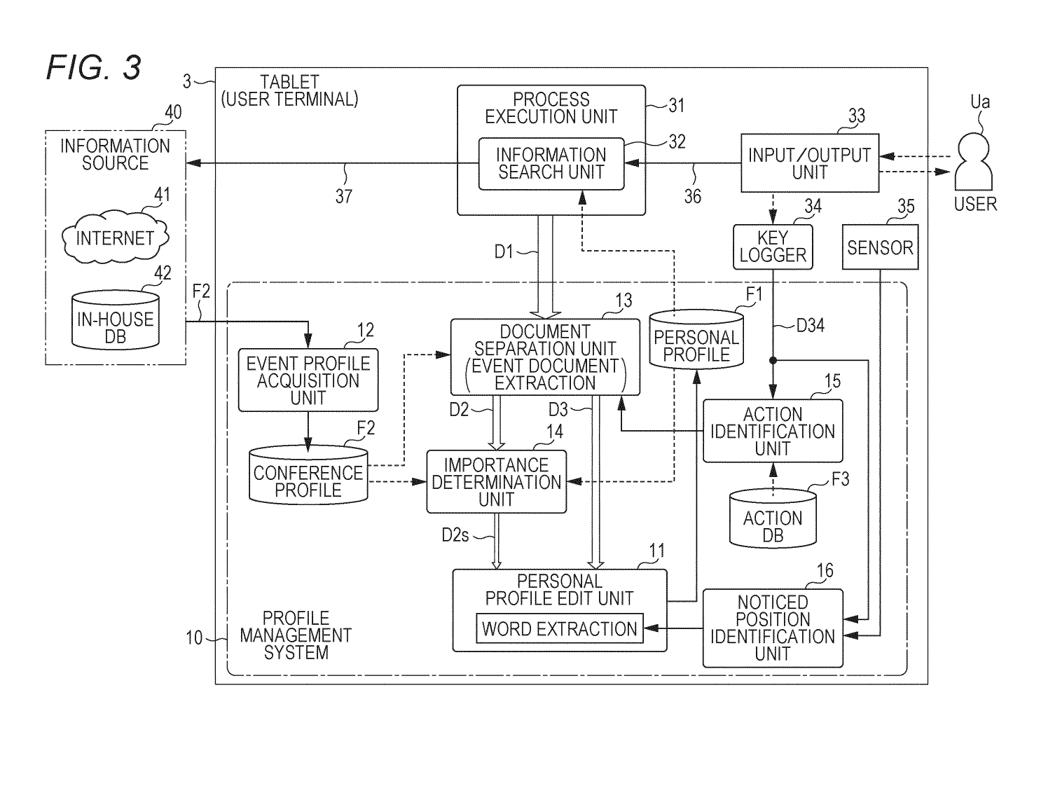

FIG. 3 shows a functional configuration of a profile management system that will be described below. In the embodiment, functional units such as a personal profile edit unit 11, a document separation unit 13, an importance determination unit 14, a noticed position identification unit 16, an action identification unit 15, a process execution unit 31, and an information search unit 32 are implemented by the CPU 21 executing programs. However, some or all of the functional units may be configured as hardware by dedicated ICs or the like. In the example of FIG. 3, the profile management system 10 is provided in a tablet 3 for use as a user terminal. However, the profile management system 10 is not limited to this but may be incorporated into an information device other than a tablet, such as a personal computer, smart phone, or PDA (Personal Digital Assistant).

The profile management system 10 takes charge of recording keywords appropriate for a personal profile F1, as part of a support system for information collection by a user Ua using the tablet 3. Prior to description on functional constituent elements of the profile management system, an overview of information collection using the personal profile F1 will be described.

The user Ua of the tablet 3 can access an information source 40 such as the Internet 41 or an in-house database 42 to acquire desired information. The user Ua performs a predetermined operation to activate the information search unit 32. The information search unit 32 constitutes a part of the process execution unit 31 that executes various processes according to instructions from the user Ua, and takes charge of execution of processes related to information search.

After the activation of the information search unit 32, the user Ua inputs a keyword according to information to be acquired. Input/output unit 33 of the tablet 3 notifies the keyword as a search key 36 to the information search unit 32. The information search unit 32 creates a search query 37 based on the search key 36 and transmits it to the information source 40. Then, the information search unit 32 causes the input/output unit 33 to display a search result from the information source 40.

After that, the user Ua displays and views a document (or a web page) presented in the search result, prints it by an MFP 8, or saves it in the storage 24. The user Ua can also input a new keyword to instruct for re-search.

In such information search, the personal profile F1 is used for automatic creation of the search query 37 by the information search unit 32. Specifically, the information search unit 32 references to the personal profile F1 at an appropriate time and automatically creates the search query 37 to narrow or widen the applicable scope of hits, based on the keyword(s) input by the user Ua and keyword(s) already recorded in the personal profile F1. The contents of the search query 37 to be created depend on mode settings. Taking simple examples, the applicable scope of hits can be narrowed by connecting the keyword(s) input by the user Ua and the keyword(s) in the personal profile F1 with “AND”, and the applicable scope of hits can be widened by connecting these keywords with “OR”. For automatic creation of the search query 37, a complicated algorithm may be applied to determine the search query 37 taking into account the number of keywords, weighing values, the classification of concepts meant by the keywords, and the like. The keyword(s) input by the user may be replaced with other appropriate keyword(s) indicative of similar meanings.

The information search unit 32 may automatically conduct information search. The information search unit 32, when activated at a preset time, uses the keyword(s) in the personal profile to create the search query 37 and search the information source 40, and suggests acquired information as recommendations to the user.

The purpose of automatic creation of the search query 37 is to allow the user Ua to easily obtain information useful to him/her. Determination on whether the information is useful to the user Ua is affected by the keywords in the personal profile F1. Accordingly, it is necessary to record in the personal profile F1 keywords indicating more precisely the trends in collecting information on what the user Ua is recently interested in.

The profile management system 10 extracts words from a document specified as a processing target by the user Ua during operations with the tablet 3, and records the extracted words as keywords in the personal profile F1. The operations with specification of a document include viewing, editing, saving, printing, transmission, deletion, and the like.

The user Ua can attend a conference carrying the tablet 3 in which conference documents are saved in advance to display and view the conference documents on the tablet 3 during the conference. In the case where the tablet 3 is used as a document viewer as described above, words are extracted from the conference documents when the conference documents are saved in the tablet 3 or when the conference documents are viewed at the conference site, or when both of them are performed.

As illustrated in FIG. 3, the profile management system 10 has the personal profile edit unit 11, the event profile acquisition unit 12, the document separation unit 13, the importance determination unit 14, the action identification unit 15, and the noticed position identification unit 16. These are functional elements implemented by the CPU 21 executing the profile management program 100.

A conference document D2s is passed to the personal profile edit unit 11 from the importance determination unit 14 and a document D3 other than the conference document is passed to the personal profile edit unit 11 from the document separation unit 13. The personal profile edit unit 11 extracts words from the conference document D2s and the document D3 according to a predetermined algorithm. Then, the personal profile edit unit 11 records the extracted words as keywords in the personal profile F1. The personal profile F1 is stored in the storage 24.

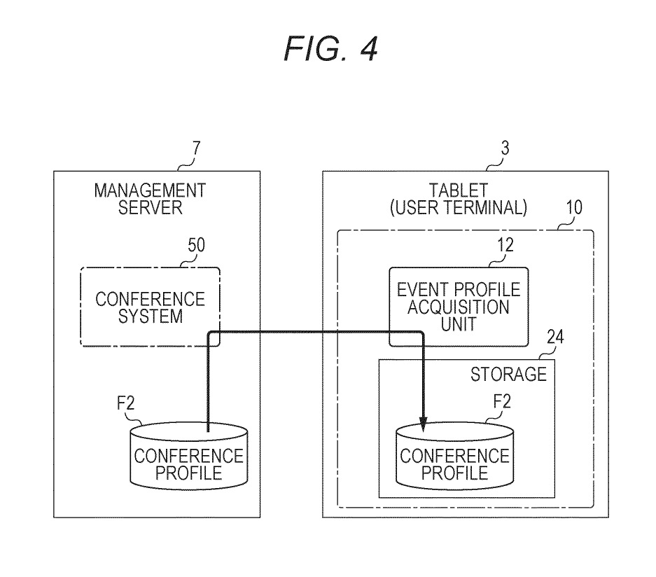

The event profile acquisition unit 12 acquires a conference profile F2 at an appropriate time from the information source 40 outside of the tablet 3. The conference profile F2 is an event profile dedicated to a conference and contains keywords featuring the contents of the conference. The conference profile F2 is created by a conference system 50 working on the management server 7 as illustrated in FIG. 4, for example.

The conference system 50 illustrated in FIG. 4 is a business support system that is introduced in a corporation where the user Ua works. The conference system 50 creates and manages the conference profile F2 and also performs various processes related to conferences such as reservation of conference rooms, automatic transmission of opening notices, counting of answers of attendance or absence, and management of conference documents. The conference system 50 transmits the latest conference profile F2 to the tablet 3 in a form responsive to a request from the event profile acquisition unit 12. As seen from the tablet 3, the management server 7 is one of the information sources 40. The transmitted conference profile F2 is stored in the storage 24 of the tablet 3.

As a timing for the event profile acquisition unit 12 to acquire the conference profile F2, a fixed time of every day can be set, for example. Alternatively, the conference system 50 can be configured to receive a notice of update of the conference profile F2 from the management server 7 so that the conference system 50 acquires the conference profile F2 at each time of update of the conference profile F2.

Returning to FIG. 3, the document separation unit 13 acquires documents D1 from the process execution unit 31 and separates the documents D1 into conference documents D2 or other documents D3. The document D1 is a document specified by the user Ua during various operations as described above. In this example, since the document D1 is acquired by the process execution unit 31 immediately after an operation or at a predetermined stage in the course of an operation, the document D1 can be said to be a document with which the user Ua is involved at this time.

The conference document D2 is an event document related to an event registered as a conference in the conference profile F2. The document separation unit 13 references to the conference profile F2 loaded into the tablet 3, and when a document D1 is a conference document D2, passes the conference document D2 (document D1) to the importance determination unit 14. When a document D1 is not a conference document D2, the document separation unit 13 passes the document D1 as a document D3 other than conference documents to the personal profile edit unit 11. The document D3 other than a conference document is a non-event document or event document related to an event other than a conference, such as a workshop or a lecture meeting.

The importance determination unit 14 determines whether conferences corresponding to the conference documents D2 are events important for the user Ua. However, the importance determination unit 14 does not determine the mind of the user Ua. Specifically, the importance determination unit 14 determines whether to regard the conferences corresponding to the conference documents D2 as important for the user Ua. The determination by the importance determination unit 14 is based on the information recorded in the conference profile F2 and the information recorded in the personal profile F1. The details of the determination will be described later.

The action identification unit 15 determines whether an action taken by the user Ua (user action) is a specific action as an impetus for word extraction from a document. The action identification unit 15 acquires log data D34 from a key logger 34 recording a history of operations on the tablet 3 and identifies the action of the user Ua with reference to information on definitions of specific actions recorded in advance in an action database.

When the user Ua takes a specific action, the action identification unit 15 instructs the document separation unit 13 to acquire the documents D1. Under the instruction, the document separation unit 13 acquires the documents D1 and the personal profile edit unit 11 extracts words from the conference documents D2s or the documents D3 as described above.

In the profile management system 10 with the function of controlling execution/non-execution of word extraction by the action identification unit 15 as described above, it is possible to customize actions associated with keywords in the personal profile F1. For example, it is possible to make a setting such that words are extracted from viewed and saved documents and no word is extracted from merely viewed documents. In addition, it is possible to make a setting such that word extraction is performed only in a predetermined time zone of one day or in a specific day of one week.

The noticed position identification unit 16 notifies the personal profile edit unit 11 of positions noticed by the user Ua in a document as a target of word extraction. The personal profile edit unit 11 extracts words at the notified positions. Accordingly, it is possible to record more reliably keywords of high interest to the user in the personal profile F1.

Output from a sensor 35 detecting the action of the user Ua is input into the noticed position identification unit 16. The sensor 35 is a camera positioned in front of the tablet 3, for example. The noticed position identification unit 16 detects a line of vision of the user Ua from an image of the user Ua watching the display 26 on which a document is displayed, and determines the position in the document watched by the user Ua. For this operation, the eye detecting technique presented at http://www.toshiba.co.jp/tech/review/2005/11/60#11pdf/rd01. pdf can be used, for example. As the sensor 35, an eye-tracking camera may be connected to the tablet 3.

The noticed position identification unit 16 also analyzes the log data D34 from the key logger 34 and notifies the personal profile edit unit 11 of the positions of underlines and markers added by the user Ua as positions noticed by the user Ua.

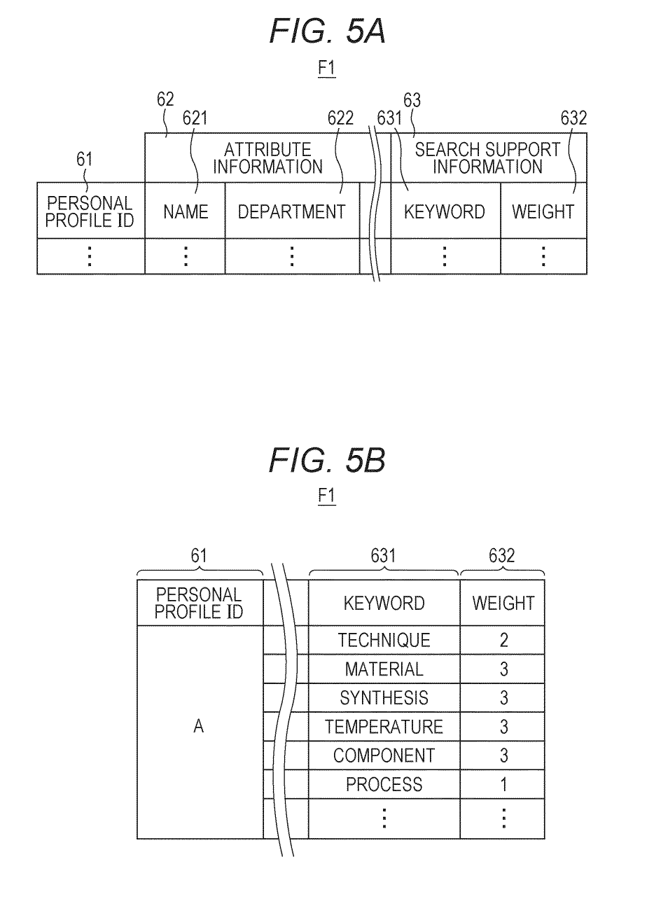

FIGS. 5A and 5B show a data configuration example of a personal profile. As illustrated in FIG. 5A, recorded in the personal profile F1 are data on items 61, 62, and 63 of “personal profile ID”, “attribute information”, and “search support information”. The item 62 (“attribute information”) is divided into a plurality of sub items and has data on the sub items 621 and 622 of “name” and “department”. The item 63 (“search support information”) is divided into sub items 631 and 632 “keyword” and “weight”.

The data on “personal profile ID” is identification information for uniquely identifying the user Ua. For example, the employee number of the user Ua at his/her corporation is set as data on “personal profile ID”. In the example of FIG. 5B, the data on “personal profile ID” is each presented as one alphabet character for the sake of convenience, but is actually a string of a predetermined number of characters. The data on “department” is a business division to which the user Ua belongs in the work place.

The data on “keyword” is a word extracted from a document viewed or printed by the user Ua as described above. The data on “weight” is a value determined according to the frequency of appearance of the corresponding word in the document as a source of extraction, which is regarded as an index for degree of importance of keyword. As seen in FIG. 5B, a plurality of words is generally recorded as data on “keyword”, and data on “weight” is associated one by one with each of the keywords.

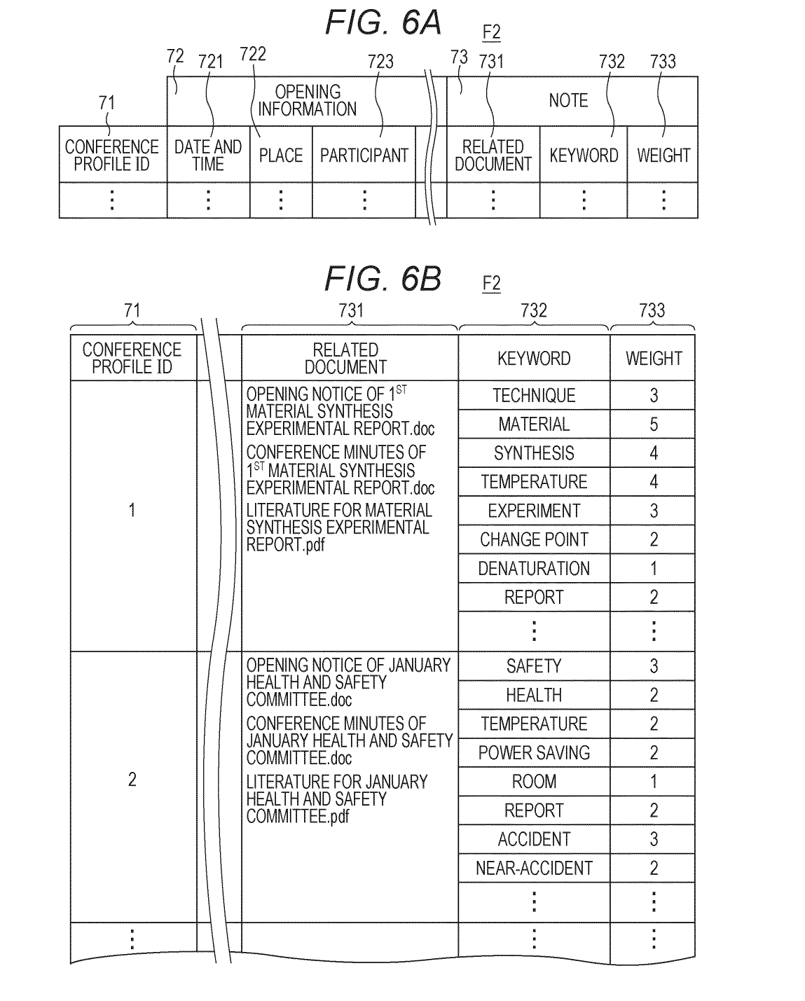

FIGS. 6A and 6B illustrate a data configuration example of a conference profile. As illustrated in FIG. 6A, recorded in the conference profile F2 are data on items 71, 72, and 73 of “conference profile ID”, “holding information”, and “note”. The item 72 (“holding information”) is divided into a plurality of sub items, and has sub items 721, 722, and 723 of “date and time”, “place”, and “participants”. The item 73 (“note”) is divided into sub items 731, 732, and 733 of “related document”, “keyword”, and “weight”. Conferences scheduled to be held are registered in the conference profile F2. Even after end of a registered conference, the data on the registered conference is not deleted but saved in the conference profile F2 until lapse of a certain period of time.

The data on “conference profile ID” is identification information for uniquely identifying conferences to be registered. In the example of FIG. 6B, the data on “conference profile ID” is each presented as one number for the sake of convenience, but is actually a string of a predetermined number of characters. For example, a combination of a classification symbol and a series number is applicable.

The data on “related document” is information for identifying conference documents as documents related to conferences. When the destination to save the documents is fixed, the document file names can be set as data on “related document”. When the destination to save the documents is not fixed, the addresses of the destinations to save the document files can be set as data on “related document”. The conference documents include documents registered in the conference system 50 by the organizer of the conference or any other person concerned (for example, opening notices and handouts). The conference documents may include e-mail automatically sent by the conference system 50 to prospective participants. As illustrated in FIG. 6B, relevant conference documents are recorded for each of the conferences identified by the conference profile IDs.

The data on “keyword” are words extracted by the conference system 50 from conference documents registered in the conference profile F2. The data on “weight” is a value determined according to the frequency of appearance of the corresponding word in the document as a source of extraction. As seen in FIG. 6B, a plurality of words is generally recorded as data on “keyword” for each of the conferences, and data on “weight” is associated one by one with each of the keywords.

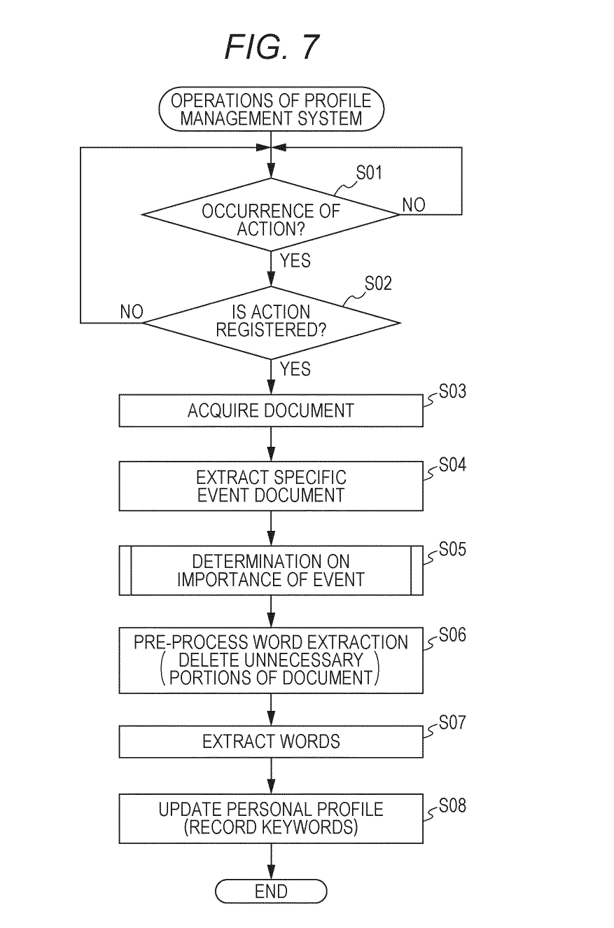

The flowchart in FIG. 7 provides an overview of operations of the profile management system 10 illustrated in FIG. 3.

The action identification unit 15 waits for occurrence of a user action recorded in the log data D34 (S01). Upon occurrence of a user action, that is, when the user Ua performs some operation, the process flow moves to step S02.

At step S02, the action identification unit 15 references to an action database F3. When the user action is registered in the action database F3 as an impetus for word extraction from a document (YES at S02), the action identification unit 15 instructs the document separation unit 13 to acquire the document. At that time, the action identification unit 15 provides the document separation unit 13 with document specification information extracted from the log data D34.

The document separation unit 13 acquires the document D1 from the process execution unit 31. Then, the document separation unit 13 searches for data on “related document” in the conference profile F2, and check if any data corresponding to the document D1 is recorded in the conference profile F2. When the document D1 is a conference document registered in the conference profile F2, the document separation unit 13 sends the document D1 as conference document D2 to the importance determination unit 14. When the document D1 is not a conference document, the document separation unit 13 sends the document D1 as document D3 other than the conference document to the personal profile edit unit 11 (S04). Accordingly, the process for separating the documents D1 can be regarded as a process for extracting specific event documents as conference documents from various documents with which the user Ua is involved.

Next, at step S05, a process for an event importance determination subroutine is performed. This determines a document as a target of word extraction by the personal profile edit unit 11. However, when the conference (event) corresponding to the conference document D2 is not determined as important, there is no document as a target. In this case, no word extraction is performed on the document D1.

When the document D1 acquired by the document separation unit 13 is determined as a target of word extraction, the personal profile edit unit 11 deletes unnecessary portions of the document D1 as a pre-process of word extraction (SO6). For example, when portions of the document noticed by the user Ua (noticed portions) are notified by the noticed position identification unit 16, portions other than the noticed portions are deleted. Alternatively, predetermined blocks in the document including the noticed portions (such as pages, chapters, or sections) may be left and other portions may be deleted. In addition, predetermined portions in predetermined kinds of documents such as headers of e-mail and banner advertisements on web pages can be deleted using a publicly known region identifying technique.

Subsequently, the personal profile edit unit 11 extracts words from the document D1 after the pre-process by using a morphological analysis method (S07), and records the extracted words in the personal profile F1. The personal profile edit unit 11 calculates the value of a weight for each keyword, and records the value of a weight in association with the keyword in the personal profile F1. When any of the extracted words is already recorded in the personal profile F1, the value of a weight already recorded is updated so as to reflect the frequency of appearance the word obtained by this-time extraction in the extraction-source document.

Words to be recorded as keywords can be limited to extracted words of high importance. There are methods for limiting keywords to words with degrees of importance equal to or more than a set value or limiting keywords to a preset number of words selected in descending order of importance. To calculate degrees of importance, a widely known TF-IDF (Term Frequency Inverse Document Frequency) method can be used, for example.

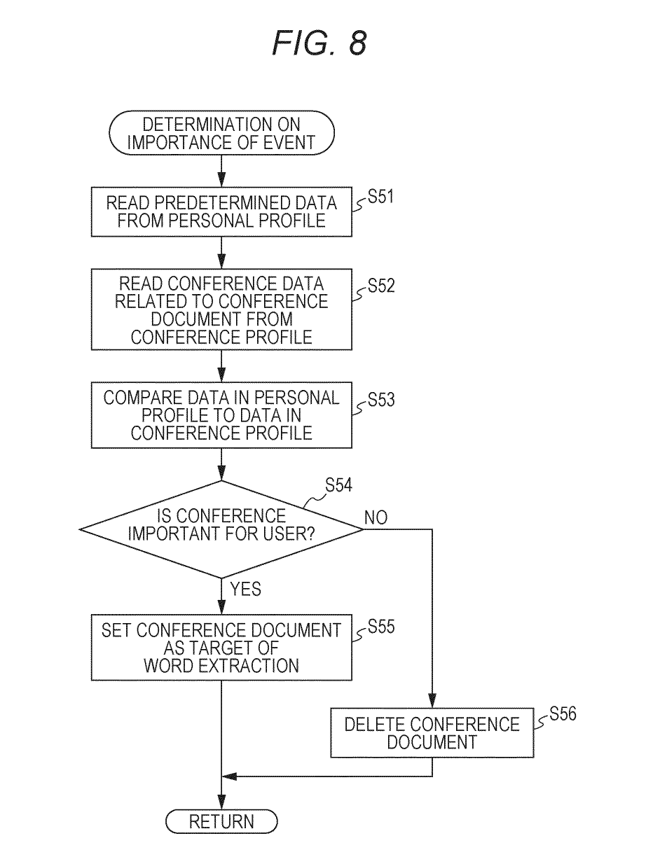

FIG. 8 is a flowchart of an event importance determination subroutine corresponding to the flowchart illustrated in FIG. 7.

The importance determination unit 14 reads predetermined data from the personal profile F1 (S51). In this example, the data on “keyword” is read. The importance determination unit 14 also reads predetermined data on a conference corresponding to the noticed conference document D2 from the conference profile F2 (S52). In this example, the data on “keyword” and “weight” are read. The data reading from the personal profile F1 may be performed before or after the data reading from the conference profile F2.

Subsequently, the importance determination unit 14 determines whether the conference corresponding to the conference document D2 is important for the user Ua based on the data recorded in the personal profile F1 and the data recorded in the conference profile F2 (S53). A specific example of determination will be provided as below.

The importance determination unit 14 compares the keywords recorded in association with the conference profile ID corresponding to the conference document D2 in the conference profile F2 with the keywords in the personal profile F1. Then, taking notice of some of the keywords in the conference profile F2 in agreement with the keywords in the personal profile F1, the importance determination unit 14 calculates the sum of weights corresponding to the noticed keywords. When the calculated sum is equal to or more than a threshold value, the importance determination unit 14 determines that the conference identified by the conference profile ID is important for the user Ua.

It is assumed here that the conference profile ID corresponding to the conference document D2 is “1” in the example of FIG. 6B. Of the keywords in the conference profile F2, the keywords “technique”, “material”, “synthesis”, and “temperature” coincide with the keywords in the personal profile F1 illustrated in FIG. 5B. When the sum of weights of the coinciding keywords is determined as a degree of coincidence, the degree of coincidence is 3+5+4+4=16, which is larger than the threshold value (15 in this example). When the degree of coincidence is larger than the threshold value, it is determined that the conference associated with the conference document D2 is important.

Meanwhile, when the conference profile ID corresponding to the conference document D2 is “2” in the example of FIG. 6B, only the keyword “temperature” in the conference profile F2 coincides with the keyword in the personal profile F1 illustrated in FIG. 5B. The weight of the keyword “temperature” is 2 and thus the degree of coincidence is 2. When the degree of coincidence is smaller than the threshold value, it is not determined that the conference corresponding to the conference document D2 is important.

As described above, some of the conference documents D2 with which the user Ua is involved are important for the user Ua and the others are not important for the user Ua. For example, it is assumed that the user Ua is an engineer mainly engaged in development of material technology in his/her corporation. When a conference with the conference profile ID of “1” is an event for reporting experimental results on material technology to persons concerned, the conference is important for the user Ua to obtain information on daily business operations. When a conference with the conference profile ID of “2” is a regular meeting of safety committees attended by the user Ua as a representative of his/her department, the conference is not important for the user Ua to obtain information on daily business operations.

However, when the user Ua belongs to the general administration division that operates a safety committee, the weights of keywords related to the safety committee in the personal profile of the user Ua are generally large. In this case, therefore, it is determined that the regular meeting of the safety committees is important for the user Ua.

Returning to FIG. 8, when it is determined that the conference corresponding to the conference document D2 is important for the user Ua (YES at S54), the importance determination unit 14 sets the conference document D2 as a target of word extraction and sends the same to the personal profile edit unit 11 (S55). When it is determined that the conference corresponding to the conference document D2 is not important for the user Ua (NO at S54), the importance determination unit 14 sets the conference document D2 as a non-target of word extraction and deletes the same (S56).

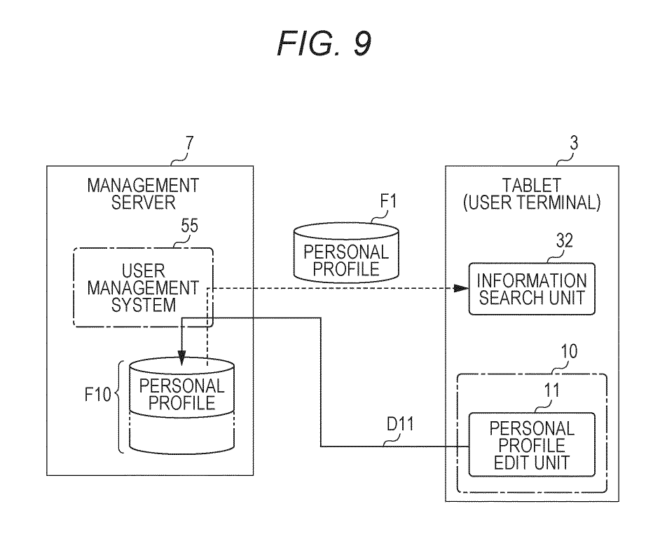

FIG. 9 illustrates a modification example of operations of the personal profile edit unit. In FIG. 9, constitutional elements corresponding to the constitutional elements in the example of FIG. 3 are given the same reference numerals as those in the example of FIG. 3.

The personal profile edit unit 11 is a functional element of the profile management system 10 incorporated into the tablet 3 in the same manner as the example of FIG. 3. When extracting words from a document, the personal profile edit unit 11 transmits keyword information D11 to be recorded in the personal profile F1 to a user management system 55 of the management server 7. Specifically, the personal profile edit unit 11 requests the user management system 55 to update the data on “keyword” and “weight” in the personal profile F1.

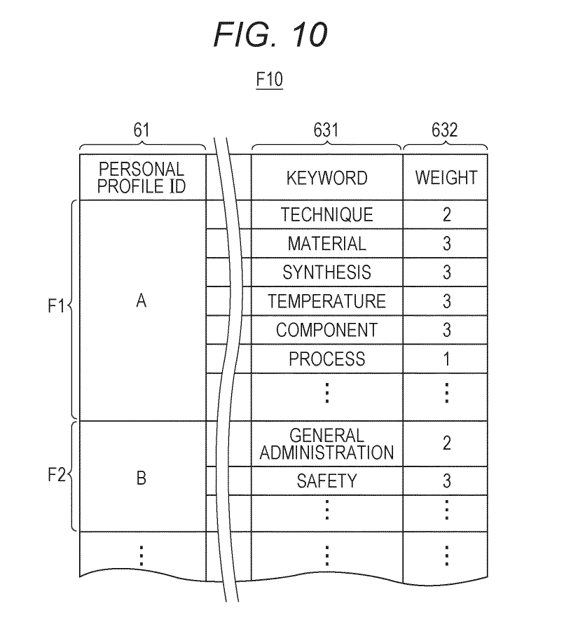

The user management system 55 performs central control on personal profiles corresponding to users of the plurality of user terminals 2 connected to the network 1. Upon receipt of the keyword information D11, the user management system 55 records the data on “keyword” and “weight” represented by the keyword information D11, in the personal profile F1 corresponding to the user Ua in personal profile group F10 configured as illustrated in FIG. 10.

Data configurations of the personal profiles F1 and F2 in the personal profile group F10 areas illustrated in FIGS. 5A and 5B. In the personal profile group F10, the data on “keyword” and “weight” are recorded for each of the users identified by the personal profile IDs.

In the example of FIG. 9, the personal profile edit unit 11 updates via the user management system 55 the personal profile F1 saved outside of the tablet 3. The latest personal profile F1 thus exists outside of the tablet 3. Accordingly, the information search unit 32 of the tablet 3 references to the personal profile F1 via the user management system 55 to automatically create a search query. Otherwise, the information search unit 32 loads the personal profile F1 at an appropriate time (for example, at startup) from the management server 7 into the tablet 3, and thereafter, references to the loaded personal profile F1.

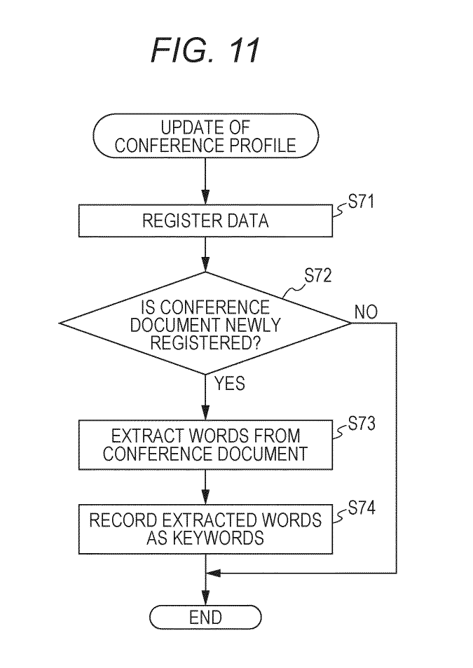

FIG. 11 is a flowchart of a process for updating a conference profile.

The conference system 50 registers data on sub items of “holding information” and data on “related document” of “note”, according to input operations by the organizer of a conference, for example (S71). Upon receipt of an instruction for registration of a new conference to be held, the conference system 50 assigns a conference profile ID to the new conference. Upon receipt of an instruction for changing of date and time or place of an already registered conference, or an instruction for new registration, replacement, or deletion of a conference document, the conference system 50 updates data on the specified items.

When a conference document is newly registered (YES at S72), the conference system 50 extracts words from the conference document (S73). Then, the conference system 50 records the extracted words as data on “keyword”. The word extraction can be performed using the TF-IDF method.

In conjunction with the recording of keywords, the conference system 50 calculates weights of the extracted keywords from the frequencies of appearance in the conference document as a source of extraction. When updating a conference document, the conference system 50 extracts words as keywords from differential portions of the document between before and after the updating, and updates the conference profile based on the frequencies of appearance of the extracted keywords. Specifically, the conference system 50 records new keywords, deletes the recorded keywords, increases or decreases the weights of the already recorded keywords.

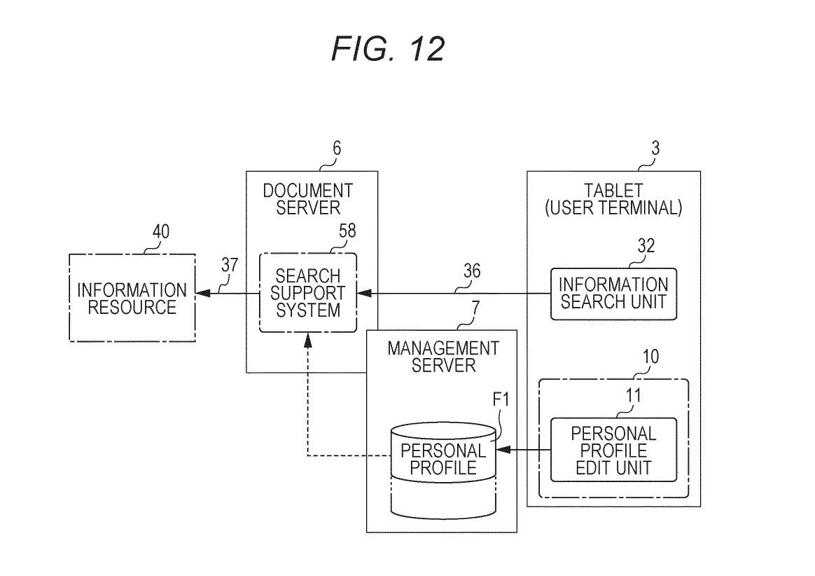

FIG. 12 illustrates a modification example of a usage mode of a personal profile. In FIG. 12, as in the example of FIG. 9 described above, the personal profile F1 is managed at the management server 7 and updated every time a word is extracted by the personal profile edit unit 11. On search through the information source 40, the personal profile F1 is referenced to by not the information search unit 32 of the tablet 3 but a search support system 58 incorporated in the file server 6. That is, the information source 40 is accessed by the tablet 3 via the search support system 58. The information search unit 32 transmits a keyword input by the user as search key 36 to the search support system 58, and the search support system 58 creates a search query 37 based on the search key 36 and the keywords in the personal profile F1.

In another mode, when the personal profile F1 is managed at a user terminal, the search support system 58 outside of the user terminal references to the personal profile F1 through communications with the user terminal.

[System Configuration 2]

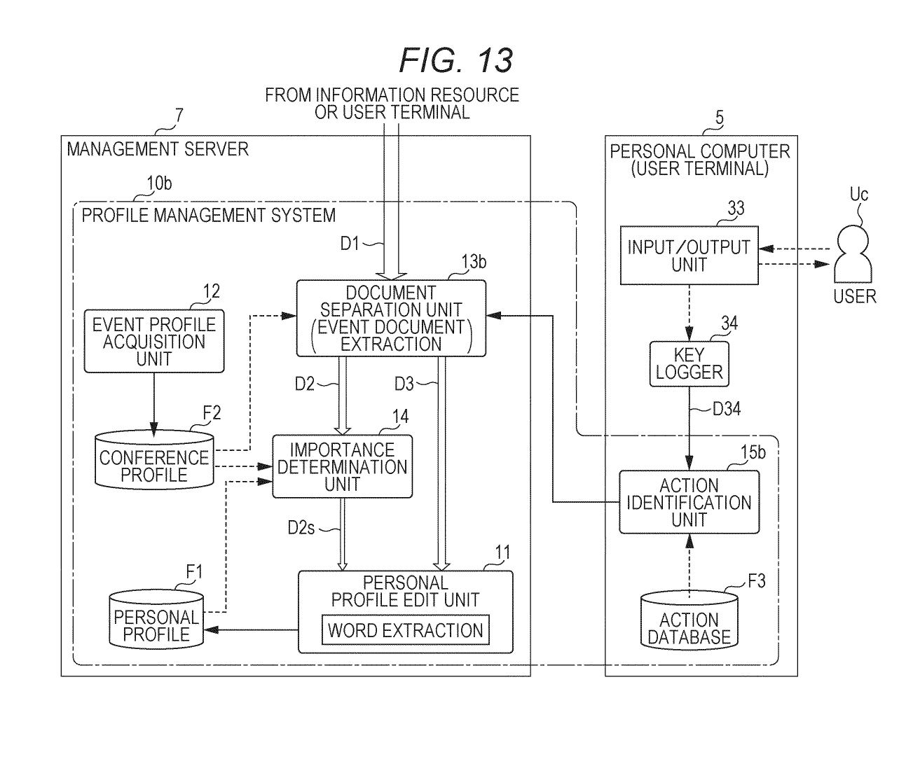

FIG. 13 illustrates another example of a configuration of a profile management system. A profile management system 10b illustrated in FIG. 13 is composed of functional elements working on a user terminal and functional elements working on a device outside of the user terminal. However, the functions of the profile management system 10b are basically the same as those in the example of FIG. 3. In FIG. 13, the user terminal is the personal computer 5, and the device outside of the user terminal is the management server 7.

In the profile management system 10b, an action identification unit 15b is provided in the personal computer 5 as a user terminal. The action identification unit 15b is a functional element implemented by executing a program installed in the personal computer 5.

The action identification unit 15b determines whether an action taken by a user Uc of the personal computer 5 is a specific action as an impetus for word extraction from a document. The action identification unit 15b acquires the log data D34 from the key logger 34 recording a history of operations on the personal computer 5, and identifies the action of the user Uc with reference to information on definitions of specific actions recorded in advance in an action database.

When the user Uc takes a specific action, the action identification unit 15b instructs a document separation unit 13b of the management server 7 to acquire the documents D1. The instruction contains information indicative of the location of the document D1. Under the instruction, the document separation unit 13b acquires the documents D1 from the information source 40 or the personal computer 5, and separates the documents D1 into the conference documents D2 recorded in the conference profile F2 and the other documents D3.

At that time, the personal profile edit unit 11 extracts words from the conference documents D2s or the documents D3 as described above.

In the profile management system 10b, the personal profile edit unit 11, the management server 7 is provided with an event profile acquisition unit 12b and the importance determination unit 14 as well as the document separation unit 13b. These elements including the document separation unit 13b are functional elements implemented by executing programs installed in the management server 7.

The event profile acquisition unit 12b loads into a work area the conference profile F2 managed by a conference system not illustrated in the management server 7, and provides the same to the document separation unit 13b and the importance determination unit 14.

The importance determination unit 14 determines whether the conferences corresponding to the conference documents D2 are important for the user Uc, as in the foregoing example. The personal profile edit unit 11 extracts words from the conference documents D2s and the documents D3 according to a predetermined algorithm. Then, the personal profile edit unit 11 records the extracted words as keywords in the personal profile F1.

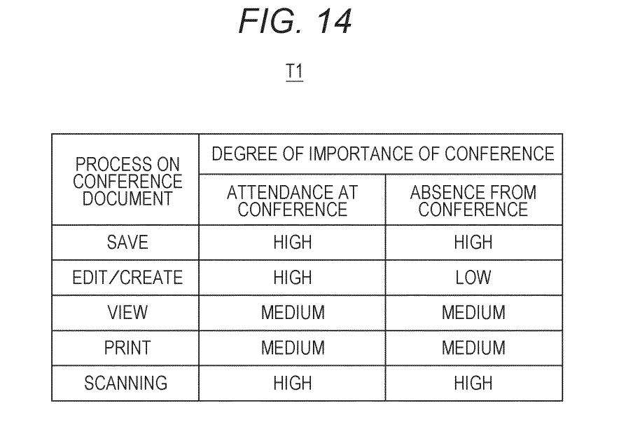

FIG. 14 shows an example of a setting table for determination on degree of importance according to combinations of processes on a conference document and attendance at/absence from a conference. For determination by the importance determination unit 14 on degree of importance of a conference, whether the user Ua, Uc will attend the conference can be set as one of determination conditions. The attendance at/absence from the conference can be identified from data on participants contained in the holding information of the conference profile F2. In addition, execution of what process on the conference document D2 is instructed by the user Ua, Uc can be added to the determination conditions. In the setting table T1 of FIG. 14, one of three degrees of importance, low, medium, and high, is associated with each of conditions with combinations of processes on the conference document and attendance at/absence from the conference.

Of the plurality of processes in the setting table T1, “save” is provided with a “high” degree of importance regardless of attendance or absence. When the user loads a conference document into a user terminal, the conference associated with the conference document can be generally considered as highly related to the user's business operations. In addition, when the user wishes to have a conference document in a user terminal, even if the user will not attend the conference associated with the conference document, the conference document can be considered as related to the user's business operations and thus is provided with a “high” degree of importance so that the conference document can be a target of word extraction.

As for “edit and create”, the degree of importance is set as “high” in the case of attendance, and is set as “low” in the case of absence. It is determined that the user is absence (does not attend) when he/she is not a prospective participant, or he/she is a prospective participant but has submitted a notice of absence, or he/she has actually not attend the conference. In general, when the user creates or edits a conference document related to a conference and attends the conference, the conference is highly related to the user's business operations. For example, when the user prepares conference literature for a conference and attends the conference, it is considered that he/she makes some presentations or suggestions at the conference. On the other hand, when the user creates or edits a conference document for a conference but does not attend the conference, he/she was asked by another person to do such tasks involved in the conference document.

With regard to “view” and “print”, the degree of importance is set as “medium” regardless of attendance or absence. It is considered that the user's interest in the conference is lower as compared to the case where the user saves the conference document in his/her user terminal, but the conference is somewhat related to the user's business operations.

For “scanning”, the degree of importance is set as “high” regardless of attendance or absence as in the case of “save”. The “scanning” is a process for optically reading the contents of a conference document recorded on paper and turning the same to electronic data, which is performed by an information device equipped with an image scanner such as the MFP 8. In a system configuration in which the importance determination unit 14 of the profile management system 10b is provided in the MFP 8, for example, the settings on “scanning” in the setting table T1 are enabled. When the user converts the contents of a conference document on paper into electronic data and stores the data in the storage of the MFP 8, the conference document is considered as important for the user. It is thus preferred that the conference document is set as a target of word extraction.

As a modification of the setting table T1, the time of occurrence of a user action may be divided into before the conference, during the conference, and after the conference for sub-division of combinations of determination conditions. For example, when the user views the conference document even after the conference, it is considered that he/she reviews it as literature related to his/her business operations, and thus the degree of importance is set as “high”, not “medium”. Accordingly, it is possible to improve the accuracy of determination on degree of importance.

When the degree of importance is divided into three or more levels as in the setting table T1 of FIG. 14, it is determined whether the conference corresponding to the conference document is important for the user by means of both the determination on degree of importance according to the setting table T1 and the determination on degree of importance according to the degree of coincidence between keywords described above. Specifically, the degrees of importance “high”, “medium”, and “low” are quantified into “10”, “5”, and “0”, respectively, for example, and when the sum of these values and the degrees of coincidence between keywords is equal to or more than a predetermined threshold value, the conference is determined as important. When the sum is less than the threshold value, the conference is not determined as important.

When the degrees of importance in the setting table T1 are set as two levels “high” and “low”, only the determination on degree of importance according to the setting table T1 may be performed without the determination on degree of importance according to degrees of coincidence between keywords. In this case, recording of data on “keyword” and “weight” in the conference profile F2 can be omitted.

According to the foregoing embodiment, since conference documents not important for the user are excluded from targets of word extraction, it is possible to prevent decrease in accuracy of information indicative of the user's interest in the personal profile F1 caused by recording of unnecessary keywords.

The necessity or non-necessity of word extraction from the conference document D2 is decided by data comparison between the conference profile F2 and the personal profile F1 both of which contain data other than keyword information. This makes it possible to update records of keywords in the personal profile F1 according to changes in the user's interest.

If it is determined whether the conference document D2 is important for the user according to the degrees of coincidence between words contained in the conference document D2 and keywords in the personal profile F1 without reference to the conference profile F2, the usefulness of the personal profile F1 may become lower. That is, the degrees of importance of all the documents D1 with which the user is involved are determined according to words contained therein, without separating the documents D1. Accordingly, the personal profile F1 has a small number of words recorded therein and the documents D1 containing a large number of words unrecorded are not determined as important. This means that keywords other than the keywords already recorded in the personal profile F1 are not newly recorded. If the personal profile F1 does not reflect the change of the user even when the user's interest has changed because he/she has been involved with a new project or has transferred to another department, the usefulness of the personal profile F1 will become lower in support of information search. According to the foregoing embodiment, it is possible to prevent such a disadvantage.

In the foregoing embodiment, to increase the accuracy of determination on degree of importance of a conference, both of words and weights are registered in the conference profile F2 so that the degree of importance of a conference can be determined according to the words and the weights. Alternatively, the degree of importance of a conference may be determined only according to words. In addition, to further increase the accuracy of determination, the degree of co-occurrence between words may be quantified as relationship between words and added to the determination conditions.

The degree of importance of a conference can be determined based on data other than keywords between the conference profile F2 and the personal profile F1. For example, the degree of importance of a conference may be determined based on the ratio or number of participants belonging to the same department as the user Ua corresponding to the personal profile F1, relative to all participants listed in the conference profile F2. Since persons often work in teams, it is probable that conferences attended by workers in the same team are highly related to their respective business operations. Therefore, when the department of the user Ua and the departments of the participants in the conference are compared to each other, if the degree of coincidence is high, the conference may be determined as important. In addition, the accuracy of determination on degree of importance of a conference can be further increased by adding a process for, when the degree of coincidence between the departments is high, increasing the degree of importance to the process for determining the degree of importance through comparison of keywords as described above.

Agendas or other bibliographic items may be added to the items in the conference profile F2 such that these data can be used for determination on degree of importance of a conference. For example, since an agenda with major and minor items for a conference frequently contains important words related to the conference, keywords in the agenda and keywords in the personal profile are compared, and when the degree of coincidence between the keywords is high, the degree of importance of the conference is increased.

In the foregoing embodiment, the document separation unit 13 acquires the documents D1 and then the importance determination unit 14 determines the degree of importance of a conference as an example. However, the present invention is not limited to this. Alternatively, first, only meta data involved in the documents D1 such as file names, for example, may be acquired to identify conference documents and determine the degrees of importance of conferences, and the documents D1 may be set as targets of word extraction, and then main data (including words) in the documents D1 may be acquired.

In the foregoing description, when the user performs an operation related to the document D1, the document D1 is acquired in real time. However, the present invention is limited to this. Alternatively, the log data D34 can be analyzed at an appropriate time after the operation, the document D1 related to the performed operation can be acquired, and words can be extracted.

Events other than conferences may be registered in the conference profile F2. The user Ua, Uc may attend events such as business trips and seminars with the purpose of collecting information necessary for his/her business operations and events for supporting other departments' operations as a collaborator of experiments or an audit commissioner for office environments. If profiles of these events are created, it is estimated that the profiles of the events attended by the users to collect information contains a larger number of keywords related to his/her business operations as compared to the profiles of the other events attended by the user. Therefore, it is possible to determine the degrees of importance of events other than conferences by checking the degrees of coincidences between the profiles of the events and the personal profile. In addition, it is possible to improve the accuracy of the personal profile by extracting words only from documents related to events with high degrees of importance and recording the same as keywords in the personal profile.

Although the present invention has been described and illustrated in detail, it is clearly understood that the same is by way of illustrated and example only and is not to be taken by way of limitation, the scope of the present invention being interpreted by terms of the appended claims.

What is claimed is:

1. A profile management system managing a profile created for an individual person, comprising:
a document separation unit that separates documents specified as targets of processing by a user of a device handling document data, into event documents related to events scheduled to be held or having been already held and other documents;
an importance determination unit that determines whether an event related to the event document separated by the document separation unit is important for the user, based on information recorded in a personal profile corresponding to the user and information recorded in an event profile corresponding to the event; and
a personal profile edit unit that extracts words from an event document related to an event determined as important by the importance determination unit, out of the event documents separated by the document separation unit, and records the words as keywords in the personal profile corresponding to the user.

2. The profile management system according to claim 1, wherein the importance determination unit determines the event as important, when a degree of coincidence determined according to the number of coinciding words between one or more words that are extracted from the event document related to the event as a target of determination and recorded as the information in the event profile and one or more words that are already recorded as the keywords in the personal profile.

3. The profile management system according to claim 2, wherein the degree of coincidence is the sum of weight values corresponding to coinciding words between the event profile and the personal profile, out of weight values corresponding to frequencies of appearance at the extraction of the words recorded together with the one or more words in the event profile.

4. The profile management system according to claim 1, wherein the importance determination unit determines the event as important, when, relative to all participants of the event recorded in the event profile, the ratio of participants coincident in attribute with the user is equal to or more than a set value.

5. The profile management system according to claim 1, wherein the importance determination unit determines whether the event is important for the user, based on setting information in which degrees of importance are set to a plurality of determination conditions with combinations of processes and participation/non-participation, according to a process specified by the user to be performed on the document as a target of processing and participation/non-participation of the user in the event.

6. The profile management system according to claim 1, wherein the importance determination unit is configured to:
extract a degree of importance according to a process specified by the user to be performed on the document as a target of processing and participation or non-participation of the user in the event, from the setting information in which degrees of importance are set to the plurality of determination conditions with combinations of processes and participation or non-participation,
extract words coinciding with the one or more words already recorded as the keywords in the event profile, from the one or more words that are extracted from the event document related to the event and recorded as the information in the event profile, and
determine the event as important, when the total value of the sum of the weight values according to the frequencies of appearance at the extraction of the words recorded in the event profile associated with the extracted one or more words and the degrees of importance extracted from the setting information, is equal to or more than a setting value.

7. The profile management system according to claim 1 comprising a server including the event profile and a terminal connected to the server, wherein
the terminal includes the document separation unit, the importance determination unit, the personal profile edit unit, and an event profile acquisition unit that acquires an event profile from the server.

8. The profile management system according to claim 1, wherein the specified process includes a document saving operation.

9. The profile management system according to claim 1, wherein the event is a conference.

10. An information device handling document data, comprising:
a document separation unit that separates documents specified as targets of processing by a user, into event documents related to events scheduled to be held or having been already held and other documents;
an importance determination unit that determines whether an event related to the event document separated by the document separation unit is important for the user, based on information recorded in a personal profile created for the user and information recorded in an event profile corresponding to the event; and
a personal profile edit unit that extracts words from an event document related to an event determined as important by the importance determination unit, out of the event documents separated by the document separation unit, and records the words as keywords in the personal profile.

11. The information device according to claim 10, wherein the importance determination unit determines the event as important, when a degree of coincidence determined according to the number of coinciding words between one or more words that are extracted from the event document related to the event as a target of determination and recorded as the information in the event profile and one or more words that are already recorded as the keywords in the personal profile.

12. A non-transitory recording medium storing a computer readable program to be executed at an information device handling document data, causing a computer included in the information device to perform:
a document separation process for separating documents specified as targets of processing by a user of the information device, into event documents related to events scheduled to be held or having been already held and other documents;
an importance determination process for determining whether an event related to the event document separated by the document separation unit is important for the user, based on information recorded in a personal profile created for the user and information recorded in an event profile corresponding to the event; and
a personal profile edit process for extracting words from an event document related to an event determined as important by the importance determination unit, out of the event documents separated by the document separation unit, and recording the words as keywords in the personal profile.

13. The non-transitory recording medium storing a computer readable program according to claim 12, wherein, in the importance determination process, the event is determined as important, when a degree of coincidence determined according to the number of coinciding words between one or more words that are extracted from the event document related to the event as a target of determination and recorded as the information in the event profile and one or more words that are already recorded as the keywords in the personal profile.

14. A profile updating method for updating a profile created for an individual person, comprising:
separating documents specified as targets of processing by a user of a device handling document data, into event documents related to events scheduled to be held or having been already held and other documents;
determining whether an event related to the separated event document is important for the user, based on information recorded in a personal profile corresponding to the user and information recorded in an event profile corresponding to the event; and
extracting words from an event document related to an event determined as important, out of the separated event documents, and recording the words as keywords in the personal profile.

15. The profile updating method according to claim 14, wherein the event is determined as important, when a degree of coincidence determined according to the number of coinciding words between one or more words that are extracted from the event document related to the event as a target of determination and recorded as the information in the event profile and one or more words that are already recorded as the keywords in the personal profile.
